(19) United States
(12) Patent Application Publication
(10) Pub. No.: US 2014/0057130 A1
(43) Pub. Date: Feb. 27, 2014

(54) Flat Steel Product, Method for Production of a Flat Steel Product and Method for Production of a Component

(71) Applicants: Ken-Dominic Flechtner, Dortmund (DE); Thorsten Koehler, Dortmund (DE); Maria Koeyer, Dortmund (DE); Manfred Meurer, Rheinberg (DE); Axel Schrooten, Dortmund (DE)

(72) Inventors: Ken-Dominic Flechtner, Dortmund (DE); Thorsten Koehler, Dortmund (DE); Maria Koeyer, Dortmund (DE); Manfred Meurer, Rheinberg (DE); Axel Schrooten, Dortmund (DE)

(73) Assignee: THYSSENKRUPP STEEL EUROPE AG, Duisburg (DE)

(21) Appl. No.: 14/003,357

(22) PCT Filed: Mar. 5, 2012
(86) PCT No.: PCT/EP2012/053716

§ 371 Date: Nov. 14, 2013

(30) Foreign Application Priority Data
Mar. 8, 2011 (DE) 10 2011 001 140.4

(51) Int. Cl. B32B 15/04; B32B 15/16; B32B 15/18

(52) U.S. Cl. CPC B32B 15/043; B32B 15/18; B32B 15/16
USPC 428/627; 428/621; 428/632; 428/628; 428/629; 427/372.2; 148/654; 72/342.1

(57) ABSTRACT

A flat steel product which is provided for forming into a component by hot pressing and which has a base layer of steel on which is applied a Zn or a Zn alloy metallic protective coating for protecting against corrosion. On at least one of the free surfaces of the flat steel product, a separate cover layer is applied which contains an oxide, nitride, sulphide, carbide, hydrate or phosphate compound of a base metal. In addition, a method which allows the production of such a flat steel product, and a method which allows the production of a component from such a flat steel product.

The invention concerns a flat steel product which is provided for forming into a component by hot pressing and which has a base layer consisting of steel on which is applied a metallic protective coating for protecting against corrosion and which is formed by Zn or a Zn alloy.

In addition the invention concerns a method for production of such a flat steel product.

Finally the invention concerns a method for production of a hot-pressed component from a flat steel product of the type according to the invention.

Where are we refer here to “flat steel products”, these include steel strips, steel sheets or plates and similar obtained therefrom.

In order to offer the combination of low weight, maximum strength and protective effect required in modern bodywork construction, today components made from high-strength steels which are hot-pressed and hardened are used in areas of bodywork which can be exposed to particularly high loads in the event of a crash.

In the hot-press hardening process, steel plates which are cut from cold- or hot-rolled steel strips are heated to a forming temperature which usually lies above the austenitising temperature of the steel concerned, and in heated state laid in the tool of a forming press. During the subsequent forming, the cut plate or the component formed therefrom undergoes a rapid cooling due to contact with the cool tool. The cooling rates are set such that a hardening structure results in the component.

A typical example of a steel suitable for hot-press hardening is known under the designation “22MnB5” and can be found in the Steel Codex 2004 under material number 1.5528.

In practice, the benefits of the MnB steels which are particularly suitable for hot-press hardening are offset by the disadvantage that steels containing manganese are generally susceptible to corrosion attack and can only be passivated with difficulty.

To improve the corrosion resistance of Mn-containing steels of the type discussed here, EP 1 143 029 B1 proposes first applying a zinc coating to a steel sheet intended for hot pressing and then heating it before the hot forming such that during heating an intermetallic connection occurs on the flat steel product by transformation of the coating on the steel sheet. This connection protects the steel sheet from corrosion and decarbonisation, and during the hot forming has a lubrication function in the pressing tool.

Despite this lubrication function allocated to the metallic protective coating in the prior art, in practical forming of plates produced in the known method it has been found that, due to friction between the formed flat product and the forming tool surfaces coming into contact therewith, high stresses occur between the metallic coating and the steel material of the flat product. These stresses can be so great that stress cracks occur in the steel material. US 2010/0269558 A1 proposes reducing the friction occurring on hot pressing of a metal workpiece in the tool by a cover layer with lubricating properties applied to the metal product. The metal product can consist of an Al material, an Mg material, a TI material or a special steel, onto which the cover layer is applied directly. The cover layer is applied in the form of a water- or alcohol-based coating fluid which contains particles of BN, Graphite, WS₂ or MoS₂. After the coating fluid has been applied to the workpiece in a specific thickness, the workpiece is exposed to an atmosphere with a relative humidity of 50-100% at 25-60° C. for at least one day in order to achieve the adhesion of the coating to the surface of the workpiece. Then the workpiece is heated to the respective forming temperature necessary for the hot pressing and the heated workpiece is formed in the forming tool. In this way it is indeed possible to reduce the friction occurring in the forming tool between the workpiece and the tool. A coating process which requires a working period of at least one day under a precisely predefined atmosphere is however unsuitable for large-scale production of a flat product in which an uninterrupted, continuous production process is essential for economic production. In addition the known method is not suitable for example for improving the formability of flat steel products with a Zn coating.

In the context of the prior art explained above, the object of the invention is to create a flat steel product with a Zn-based coating which has optimum suitability for hot pressing. In addition a method is proposed which allows the production of such a flat steel product, and a method which allows the production of a component from such a flat steel product.

In relation to the flat steel product, this object is achieved according to the invention with the features given in claim 1.

According to the invention, a method for production of the flat steel product according to the invention comprises the measures given in claim 12.

For production of a component from a flat steel product according to the invention, the invention proposes the measures given in claim 19.

Advantageous refinements and variants of the invention are given in the dependent claims and are explained below in more detail, together with the general inventive concept.

A flat steel product according to the invention provided for forming into a component by hot pressing has a base layer of steel, onto which is applied a corrosion-protective metallic layer which is formed by Zn or a Zn alloy.

According to the invention, on at least one of its free surfaces, the flat steel product is now also given a separate cover layer which contains an oxide, nitride, sulphide, carbide, hydrate or phosphate compound of a base metal. According to the invention, a cover layer is then applied in a separate working process and independent from the other coatings present optionally on the flat steel product according to the invention. This cover layer acts in the manner of a lubricant and thus improves the suitability of flat steel products according to the invention for forming into a component by hot pressing.

Base metals from which the oxide, nitride, sulphide, carbide or phosphate compounds present according to the invention are formed, in the sense of the invention include all metals which even under normal conditions react with the oxygen of the atmosphere. In addition the base metals here also include alkaline earth metals, alkali metals and semimetals, also called metalloids, and the transition metals.

The steel base layer of a flat steel product produced according to the invention typically comprises Mn-alloy steel, as already provided in various embodiments in the prior art for hot pressing. Such steels have typical contents of 0.1 to 3 wt. % Mn and contents of B in order to achieve the strength level required. Such flat steel products made of such steels are usually highly susceptible to corrosion and are therefore usually coated with a Zn-based metallic protective layer to protect them from corrosion. The cover layer according to the invention has proved particularly effective for hot pressing of such flat steel products in which a corrosion-protective layer of Zn or a Zn alloy is applied to a steel base layer of the flat steel product and the cover layer then applied onto this.

It has been proven that on hot pressing of flat steel products which have a metallic Zn or Zn-alloy protective layer and a cover layer lying thereon in the manner of the invention, around 80% fewer cracks are formed than on comparison products which had the same protective layer but were hot-pressed without the cover layer according to the invention.

The compounds present in a cover layer provided according to the invention include for example compounds of the alkaline earth metals such as Mg₃Si₄O₁₀(OH)₂, MgO or CaO₃, alkali metal compounds, K₂Co₃ or Na₂Ca₃, compounds of semimetals such as BN, Al₂O₃ (cubic), SiO₂, SnS, SnS₂ and compounds of the transition metals such as TiO₂, Cr₂O₃, Fe₂O₃, Mn₂O₃, ZnS.

A cover layer according to the invention leads to a decisive reduction in friction during forming of a flat steel product according to the invention in the respective forming tool. This applies in particular if the metal compounds provided according to the invention in the cover layer are applied in the form of particles, wherein this includes the possibility that the particles together form a dense, compact cover layer. On forming of a flat steel product according to the invention then optimum results are achieved if the mean diameter of the particles in the compound amounts to 0.1 to 3 μm.

Alternatively the cover layer according to the invention can also be applied as a solution from which metallic salts form during drying, forming a crystalline coating on the flat steel product.

The particular advantage of the composition of the cover layer according to the invention in this respect lies in that even at the high temperatures at which hot forming of a flat steel product coated according to the invention takes place, they develop their effect reliably. With no special measures being required, the cover layer applied according to the invention adheres so firmly to the respective steel substrate that only minimum abrasion and minor adhesions result both in the oven used for heating the plates and in the forming tool.

The latter has proved particularly advantageous if a flat steel product coated according to the invention is heated to the forming temperature in a continuous passage oven where it is advanced on rotating oven rollers. The cover layer composed according to the invention on a flat steel product according to the invention here only sticks to the oven rollers to a small extent, so that the wear on the rollers and the expense necessary for their maintenance are minimised.

Practical experiments in this connection have shown that even after direct temperature stressing in the temperature range typical for hot pressing from 700 to 950° C., the cover layer composed according to the invention retains all its required properties for a sufficiently long period, in particular remains stable at the high temperatures long enough to complete the forming of the respective flat steel product coated according to the invention.

The cover layer according to the invention has no detrimental effect on the desired oxide layer formation of the metallic Zn-based coating during the heating phase for hot forming. Also the presence of the cover layer according to the invention causes no disadvantages for further processing. In particular the cover layer according to the invention does not hinder the suitability for welding, gluing, painting or the application of other coatings. Consequently there is no need to remove the cover layer according to the invention between the hot pressing and the working steps subsequently performed on the resulting component.

The cover layer applied according to the invention bridges the substantial base roughnesses which form on the respective surface of the flat steel product during heating for the subsequent hot pressing. Practical experiments in this respect have shown that the cover layer applied according to the invention should be as thin as possible, in particular only 0.1 to 5 μm thick.

In particular the coating weight with which the cover layer according to the invention is applied to the protective coating of the flat steel product, on the finished product should amount to 15 g/m², in particular up to 5 g/m². Firstly with such a coating weight the friction-reducing effect of the cover layer in the forming tool can be exploited to the full. Secondly, negative influences on the results of the working steps performed in further processing of a flat steel product according to the invention are excluded particularly reliably with a thin cover layer according to the invention.

Because of the high precision with which the Zn or Zn-alloy coatings can be applied to Mn-containing steel substrates, optimum working results are achieved in particular in forming flat steel products coated according to the invention which have a Zn-alloy coating applied electrolytically such as a ZnNi-alloy coating, and in which the steel contains 0.3 to 3 wt. % Mn. On hot pressing, such flat steel products show minimum susceptibility to cracking if given a friction-reducing cover layer in the manner of the invention.

With the invention therefore a flat steel product is provided with which the risk of stress cracks occurring is reduced to a minimum.

For production reasons, the decisive advantage of the cover layer according to the invention lies in that its application to the metallic protective coating of the steel base layer of a flat steel product can easily be included in a continuous production process.

The method according to the invention for production of a flat steel product described above comprises at least the following working steps:
provision of a fiat steel product comprising a steel base layer which is coated on at least one of its surfaces with a metallic protective layer formed from a Zn or Zn alloy,
application of a cover layer to the fiat steel product by application of a coating fluid to the metallic protective layer of the flat steel product, wherein the coating fluid consists (in wt. %) of 5 to 50% of an oxide, nitride, sulphide, carbide, hydrate or phosphate compound of a base metal, and 1 to 20% of a binder and the remainder a solvent,
setting of the thickness of the cover layer, and
drying of the cover layer.

The working steps provided for the coating of a flat steel product according to the invention can for example be carried out in a hot dip coating or electrolytic coating plant, following the process steps necessary for application of the metallic Zn-based protective layer, in a coating apparatus which stands in line with the workstations necessary for application of the metallic Zn-based protective layer and which the flat steel product emerging from the last of these workstations enters in a continuous, uninterrupted movement process. Evidently the cover layer can also be applied in a separate, continuously working plant.

Depending on the quantity of further constituents of the coating fluid applied to the metallic Zn-based protective layer of the fiat steel product, with the procedure according to the invention a cover layer results which consists to 20-98% of the oxide, nitride, sulphide, carbide, hydrate or phosphate compound of the base metal concerned and the remainder of other components.

Whereas the compounds of the respective base metal contained in a coating fluid applied according to the invention make the essential contribution to minimising the friction present in the tool during hot pressing, the binder also present in the coating fluid ensures a sufficiently firm binding of the cover layer formed by the coating fluid to the metallic protective layer, consisting of Zn or Zn alloy, on the flat steel product.

The binder concerned can for example be an organic or inorganic binder such as for example water glass or cellulose. The binder concerned fixes the coating applied according to the invention to the Zn-based protective layer and prevents the coating applied according to the invention from detaching before the sheet forming process.

If a natural or synthetically produced organic binder is used, this is preferably water-soluble and easily dispersible so that water can be used without problems as a solvent for the coating fluid. Examples of organic binders concerned are cellulose ester, cellulose nitrate, cellulose acetobutyrate, styrene acrylacetate, polyvinyl acetate, polyacrylate, silicone resin and polyester resin. The organic binder should be selected such that it combusts with minimum residue during application or drying of the coating fluid or during the heating carried out for the hot forming. This has the advantage that the binder reliably has no detrimental effect on the weldability. Also the organic binder should not contain halogens such as fluorine, chlorine or bromine, which during the combustion process (hot forming) could lead to the emission of harmful, explosive or corrosive compounds.

Particularly good coating results are also found if an inorganic binder is used. After heating and the press hardening process, these inorganic binders remain on the flat steel product so that they are often also found in the cover layer of the finished product. Typical examples of inorganic binders of the type concerned are silizanes, potassium silicate (K₂O—SiO₂), sodium silicate (Na₂O—SiO₂), (H₂SiO₃) or SiO₂.

The liquid carrier, i.e. the solvent containing the other constituents of the coating fluid applied according to the invention, is preferably water which evaporates easily during drying of the cover layer and can be extracted as water vapour at low cost with environmentally harmless disposal. The solvent content of a coating fluid applied according to the invention is then typically 15-80 wt. %, in particular regularly more than 50 wt. %. Alternatively to water, oils and alcohols can also be used as solvents insofar as these evaporate rapidly and constitute no danger to persons or equipment in the application area.

As well as its main constituents of “oxide, nitride, sulphide, carbide, hydrate or phosphate compound of a base metal” and binder, the coating fluid applied according to the invention to the metallic Zn-based protective layer can contain constituents which for example improve the wetting properties or the distribution of the compound contained therein according to the invention.

Practical experiments have shown that optimum coating results are achieved if the coating fluid contains 5 to 35 wt. % of the oxide, nitride, sulphide, carbide, hydrate or phosphate compound component. With such contents of the compound component concerned in the coating fluid, cover layers are achieved which consist up to 94 wt. % of the oxide, nitride, sulphide, carbide, hydrate or phosphate compound of a base metal.

With regard to minimising process times and optimising the coating result, it is positive if the temperature of the coating fluid on application is 20 to 90° C., in particular 60 to 90° C. The same purpose is achieved if the temperature of the flat steel product on application of the coating fluid is 5 to 150° C., in particular 40 to 120° C. The temperature of the flat steel product desired for the working step “application of the cover layer”, with a suitably close succession of working steps, can be carried forward from the preceding working step “application of the metallic protective layer”. In this case there is no need for an additional heating device.

Alternatively it is also possible to apply the cover layer according to the invention during a preparatory working step before the hot pressing. Here the heating necessary for the hot pressing can be used to dry the cover layer. It may be suitable to transport the flat steel product, after coating with the Zn protective layer, first to the subsequent processing station and there apply the cover layer shortly before the flat steel product enters the hot forming oven in which the flat steel product is heated to the temperature necessary for the hot forming.

The coating fluid can be applied by dipping, spraying or other conventional application processes.

The layer thickness can be set to the respective predefined layer thickness, preferably lying in the range from 0.1 to 5 μm, in a conventional manner by squeeze-rolling, blowing off excess fluid, variation of the solids proportion of the coating fluid, or changing the temperature of the coating fluid.

The cover layer applied according to the invention is typically dried at 100 to 300° C., wherein the typical drying time lies in the range from 5 to 180 seconds. Both the drying temperature and the drying times are dimensioned such that the drying process can be carried out easily in conventional drying apparatus through which the respective flat steel product is guided in a continuous process.

The steel strip coated in the manner of the invention can then be wound into coils and transported for further processing. The further process steps necessary to produce a component from the flat steel product according to the invention can be performed at the further processing station at a separate location and time.

Thanks to the minimised friction which occurs during forming on contact of the forming tool with the flat steel product having the cover layer according to the invention, crack-free components for which high degrees of stretching or complexly structured deformations are required for forming can be produced by hot pressing from flat steel products coated according to the invention. The method according to the invention for production of a hot-pressed component provides here that a plate is cut in the known manner, for example by laser cutting or using another conventional cutting device, from a flat steel product with a cover layer of the type according to the invention, which plate is then heated to a forming temperature above 700° C. and formed into the component in a forming tool. In practice the typical forming temperatures lie in the range from 700 to 950° C. with heating times of 3 to 15 minutes.

In the case of processing a flat steel product, the base layer of which is made from steel containing 0.3 to 3 wt. % Mn, optimum working results are achieved for example if the temperature of the plate or component is maximum 920° C., in particular 830 to 905° C. This applies in particular if the forming of the steel component is carried out as hot forming following heating to the plate or component temperature, such that the heated plate (“direct” method) or the heated steel component (“indirect” method) is laid in the forming tool subsequently used with a certain temperature loss. The respective final hot forming can then be carried out particularly reliably if the plate or component temperature on leaving the heating oven amounts to 850 to 880° C. Depending on the transport routes, transport times and ambient conditions, the component temperature in the tool in practice is regularly 100-150° C. lower than the temperature on leaving the heating oven.

The component obtained by forming at such high temperatures can be cooled in the known manner in an accelerated fashion starting from the respective forming temperature in order to produce hardening structures in the component and thus achieve optimum load-bearing capacity.

The reduced friction in the forming tool, due the cover layer applied according to the invention, makes a flat steel product according to the invention particularly suitable for single-stage hot pressing because of the lack of susceptibility of the flat steel product coated according to the invention to cracking of the steel substrate and abrasion; in said single-stage hot pressing, a hot forming and cooling of the steel component are carried out in one process in the respective forming tool utilising the heat from the heating previously applied.

The properties of a flat steel product coated according to the invention naturally have an equally positive effect on two-stage hot-press hardening. In this process variant first the plate is formed and then the steel component is formed from this plate without intermediate heat treatment. The steel component here is typically formed in a cold-forming process in which one or more cold-forming operations are carried out. The degree of cold forming can be so high that the steel component obtained is formed substantially completely. However it is also conceivable to carry out the first forming as preforming and then after heating, to form this steel component finally in a forming tool. This final forming can be combined with the hardening process in that hardening is carried out as form hardening in a suitable forming tool. The steel component is laid in a tool reflecting its finished final form, and cooled sufficiently quickly for the desired hardening or annealing structure to form. Form hardening thus allows particularly good form stability of the steel component.

Irrespective of which of the two variants of the method according to the invention is used, neither forming nor the cooling required to form the hardening or annealing structure need be carried out in a particular manner deviating from the prior art. Rather known methods and existing appliances can be used for this purpose.

The component obtained according to the invention can then be subjected to conventional joining and coating processes.

The invention is now explained in more detail with reference to exemplary embodiments.

### EXPERIMENT 1

To produce a hot-pressed component from a cold-rolled and re-crystallising annealed steel strip for example 1.5 mm thick, which consists of a steel known under the designation “22MnB5” and listed in the Steel Codex 2004 under material number 1.5528, the steel strip was subjected to an in-line cleaning treatment. Such a cleaning treatment can comprise an alkali cleaning bath with a spray cleaning using brushes, electrolytic degreasing, clear water rinsing again carried out using brushes, pickling with hydrochloric acid and a further water rinsing.

The strip steel pretreated in this way was given a ZnNi-alloy coating in an electrolytic coating device, forming a Zn or Zn-alloy coating protecting the steel substrate from corrosion and other attack. The measures carried out here are explained in detail in PCT application PCT/EP2010/052326, the content of which is included in the present application to supplement the disclosure in this regard.

The strip steel, thus electrolytically coated with a 10 μm thick ZnNi protective layer and heated to 120° C., was then dipped in a coating fluid which according to the invention contained 20 wt. % calcium carbonate as carbonate of a base metal, 5 wt. % of a silicate compound K₂O—SiO₂ as binder, and the remainder water. Then the thickness of the cover layer applied in this manner to the ZnNi protective layer of this steel strip was set by squeezing out the still liquid coating fluid, and the cover layer was then dried in a drying oven. The thickness of the cover layer set after the dip-coating was dimensioned such that the cover layer thickness at the end of the drying process was 2 μm on each side of the steel strip. The drying carried out on passage through the drying oven took place at an oven temperature of 120° C. within 5 seconds. The layer thickness can alternatively also be set by varying the proportion of the base metal compound, varying the bath temperature, or blowing off.

Plates were cut from the steel strip coated in this way, which were then heated to a hot forming temperature amounting for example to 880° C. on leaving the heating oven, hot pressed in a conventional one-stage hot-press hardening tool into a steel component, and then cooled so rapidly that hardening structures formed in the steel substrate. The resulting hot-pressed and hardened steel components were crack-free.

### EXPERIMENT 2

In a second experiment, plates were cut from a steel strip consisting of the steel material 22MnB5 and coated in the conventional manner with a 10 μm thick Zn—Fe protective layer by hot-dip coating and subsequent galvannealing.

The plates were then coated by spraying with a coating fluid at a plate temperature of 120° C. which contained, as well as water, 15 wt. % of a hydrate of a base metal in the form of monoclinic talc as a forming aid according to the invention, and a further 10% of the silicate compound Na₂O—SiO₂ as inorganic binder to bind the cover layer to the metallic protective coating.

After setting the thickness of the cover layer applied in this way by squeezing, the plate was dried in a drying oven. The thickness of the layer was set such that the finished cover layer after drying had a thickness of 1.5 μm per side. Drying took place within 8 seconds in continuous passage in an NIR drying line.

After heating to a plate temperature amounting to 890° C. on leaving the heating oven, the plates coated in this way were formed by hot pressing with subsequent hardening to give crack-free steel components.

### EXPERIMENT 3

A steel strip of 22MnB5 steel, given a 10 μm thick Zn-Fe protective coating in a galvannealing process by hot dipping with subsequent heat treatment, was given a cover layer by spraying of a coating fluid at a steel strip temperature of 60° C., following directly in time and place after the hot-dip process at the outlet from the galvannealing coating plant used to apply the protective coating. The coating fluid according to the invention contained 15 wt. % of a nitride of a semimetal in the form of boron nitride and a further 5 wt. % of the silicate compounds (Na₂O-SiO₂, K₂O-SiO₂) as inorganic binder to bind the cover layer to the Zn-Fe protective coating of the steel strip, and the remainder water.

The thickness of the cover layer applied to the protective coating was set while the cover layer was still wet, such that the thickness of the cover layer in dry state was 0.1 to 5 μm and on average 1 μm per side. The thickness of the cover layer was set by varying the spray pressure and the rate at which the steel strip emerged from the coating plant.

The cover layer was dried within 180 seconds at 120° C. in a convection dryer arranged in line with the coating plant, through which the strip moved continuously to the coating plant. The corrosion-protection coating and the cover layer could thus be applied particularly economically in an uninterrupted, continuous passage.

Plates were cut from the coated steel strip and heated to a plate temperature of 890° C. on leaving the heating oven, and then formed by hot pressing with subsequent hardening into crack-free steel components.

### EXPERIMENT 4

Sheet steel plates of 22MnB5 steel, coated electrolytically with a 10 μm thick Zn—Ni corrosion-protection coating, were given a cover layer by spraying with a coating fluid in a process separate in time and place from the production of the protective coating and immediately before the heating to 890° C. necessary for hot pressing of the flat steel product. The coating fluid in this case contained, in the manner according to the invention, 25 wt. % of a sulphide of a base metal in the form of zinc sulphide, a further 2% silizane as binder to bind the cover layer to the metallic protective coating, and the remainder a highly volatile mineral oil.

The thickness of the still wet cover layer applied in this way was then set so that it was between 1 and 6 μm and on average was 3 μm on each side of the plate. The layer thickness was set by varying the spray pressure and substrate speed at the inlet to the heating line in which the plates were heated to the hot forming temperature necessary for hot pressing, which was 880° C. on leaving the heating line. The cover layer was dried in a first segment of the heating line which can be designed separately or together with the remaining heating line.

The steel plates coated in this way were then heated to a plate temperature of 860° C. on leaving the heating oven, and formed by hot pressing with subsequent hardening into crack-free steel components.

### EXPERIMENT 5

A 1.5 mm thick steel sheet consisting of 22MnB5 steel, coated electrolytically with a 10 μm thick, galvannealed, Zn-Fe protective layer with subsequent heat treatment, was given a cover layer by dipping in a coating fluid at a sheet temperature of 120° C.

The coating fluid here contained, as well as water, according to the invention 25 wt. % of a carbonate of an alkaline earth metal in the form of calcium carbonate (CaCO₃), and to bind the cover layer to the metallic protective coating, 8 wt. % cellulose ester as binder which was dissolved in the water of the coating fluid. After evaporation of the water, the organic film former ensured a good adhesion and anchoring of the calcium carbonate particles on the zinc-based protective coating and contributed to the particularly good weldability of the components hot-pressed from the steel sheet.

The thickness of the cover layer applied to the protective coating in this case too was set in the wet state such that the cover layer after drying was between 0.1 and 5 μm and on average 2.5 μm thick per side. The layer thickness of the wet cover layer was set by blowing off surplus coating fluid. Here too, as in all other exemplary embodiments described, alternatively or additionally the thickness of the cover layer can be set by varying the solids proportion of the coating fluid or the bath temperature. After setting the layer thickness, the cover layer was dried within 5 seconds at 150° C. in a continuous passage oven.

The sheet steel with the protective coating and a cover layer according to the invention thereon was then heated to a plate temperature of 880° C. on leaving the heating oven, and formed by hot pressing with subsequent hardening into crack-free steel components.

### EXPERIMENT 6

Sheet steel plates consisting of 22MnB5 steel were coated by hot-dipping with a 10 μm thick Zn—Ni corrosion-protection coating. Then a cover layer was applied to the sheet steel plates which had a temperature of 20° C. and the protective coating, by spraying a coating fluid which in the manner according to the invention contained 15 wt. % of a hydrate of a base metal in the form of monoclinic talc.

In addition, to bind the cover layer to the metallic protective coating, the coating fluid contained as binder a further 10 wt. % vinyl acetate which was polymerised as a dispersion in water. This organic binder ensured by cross-linking a good anchoring of the magnesium-silicate-hydrate to the zinc-based coating. The rest of the coating fluid consisted of water.

The thickness of the cover layer was set by squeezing the still liquid cover layer. Squeezing was followed by drying which took place within 8 seconds at a drying temperature of 140° C. The thickness of the cover layer applied to the protective coating was set in the wet state such that in dry state, the cover layer was between 0.1 and 5 μm and the thickness was on average 2 μm per side.

The sheet steel plates were then heated to a plate temperature of 920° C. on leaving the heating oven and by hot pressing with subsequent hardening, formed into crack-free steel components.

### EXPERIMENT 7

Sheet steel plates consisting of 28MnB5 steel, coated electrolytically with a 10 μm thick Zn—Mg corrosion-protection coating, were given a cover layer by spraying with a coating fluid in a process separate in time and place, directly following the production of the Zn—Mg protective coating.

The coating fluid in this case contained, as well as water, 25 wt. % of a sulphide of a base metal in the form of zinc sulphide, and a further 7% silizane as binder to bind the cover layer to the metallic protective coating. The wet layer applied in This way was then dried in an NIR dryer. The wet layer was set to give a dry layer of 3 μm per side. Drying took place in continuous passage in a time of 3 seconds.

Crack-free components were then produced by hot pressing with subsequent hardening from the plates coated in this way after heating to a plate temperature amounting to 890° C. on leaving the heating oven.

1. A flat steel product which is provided for forming into a component by hot pressing, the flat steel product comprising a base layer comprising steel on which is applied a metallic protective coating for protecting against corrosion comprising a Zn or a Zn alloy, wherein on at least one of the free surfaces of the flat steel product a separate cover layer is applied which comprises an oxide, nitride, sulphide, carbide, hydrate or phosphate compound of a base metal.

2. The flat steel product according to claim 1, wherein the metal of the compound belongs to the group of alkaline earth metals.

3. The flat steel product according to claim 1, wherein the metal of the compound belongs to the group of alkali metals.

4. The flat steel product according to claim 1, wherein the metal of the compound belongs to the group of semimetals.

5. The flat steel product according to claim 1, wherein the metal belongs to the group of transition metals.

6. The flat steel product according to claim 1, wherein the metal of the compound belongs to the group consisting of Na, K, Mg, Ca, B, Al, Si, Sn, Ti, Cr, Mn, and Zn.

7. The flat steel product according to claim 1, wherein the compound present in the cover layer is present in the form of particles.

8. That flat steel product according to claim 7, wherein the mean diameter of the compound particles is 0.1 to 3 μm.

9. That flat steel product according to claim 1, wherein the cover layer comprises 20 to 98% of the compound.

10. The flat steel product according to claim 1, wherein the cover layer is 0.1 to 5 μm thick.

11. The flat steel product according to claim 1, wherein the steel comprises 0.3 to 3 wt. % manganese.

12. A method for production of a flat steel product composed according to claim 1, comprising the following working steps:
providing a flat steel product having a metallic protective layer comprising a Zn or Zn alloy,
applying a cover layer to the flat steel product by application of a coating fluid to the metallic protective layer of the flat steel product, wherein the coating fluid consists (in wt. %) of 5 to 50% of an oxide, nitride, sulphide, carbide, hydrate or phosphate compound of a base metal, 1 to 20% of a binder and the remainder a solvent,
setting the thickness of the cover layer, and
drying the cover layer.

13. The method according to claim 12, wherein the coating fluid contains 5 to 35 wt. % of the compound.

14. The method according to claim 12, wherein the solvent is water.

15. The method according to claim 12, wherein the temperature of the coating fluid on application is 20 to 90° C.

16. The method according to claim 12, wherein the temperature of the flat steel product on application of the coating fluid is 5 to 150° C.

17. The method according to claim 12, wherein the cover layer is dried at 100 to 300° C.

18. The method according to claim 12, wherein the cover layer is dried within 5 to 180 seconds.

19. A method for production of a hot-pressed component, wherein a plate is cut from a flat steel product composed according to claim 1, wherein the plate is heated to a forming temperature lying above 700° C. and wherein the plate is formed into a component in a forming tool.

20. The method according to claim 19, wherein the formed component is cooled in an accelerated manner from the forming temperature in order to create hardening structures in the component.
